(19) United States
(12) Patent Application Publication
(10) Pub. No.: US 2005/0059160 A1
(43) Pub. Date: Mar. 17, 2005

(54) Method and apparatus for quantifying a rapid immunochromatographic test

(76) Inventors: Hansen-H. Tsai, Tainan City (TW); Cheng-Yang Huang, Tainan City (TW); Heng-Chang Chang, Tainan City (TW); Jeng-Lung Chen, Cishan Township (TW); I-Chang Jou, Pingjhen City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/690,699

(22) Filed: Oct. 23, 2003

(30) Foreign Application Priority Data
Sep. 17, 2003 (TW) 092125560

(51) Int. Cl. G01N 1/00

(52) U.S. Cl. 436/174

(57) ABSTRACT

A method for quantifying a rapid immunochromatographic test includes the steps of: acquiring a digital image of a rapid immunochromatographic test with an image acquiring unit, acquiring at least one main characteristics of the digital image with a characteristics acquiring unit, calculating and quantifying the main characteristics of the digital image with a neural-network quantifying unit, and sending results of the quantification to an output unit.

### BACKGROUND OF THE INVENTION

1. Field of the Invention

The present invention relates to a method and apparatus for quantifying a rapid immunochromatographic test, more particularly one, which acquires main characteristics of a rapid immunochromatographic test through optical image technology, and quantifies the main characteristics through a neural-network quantifying unit, and displays the result of the quantification through an output unit.

2. Brief Description of the Prior Art

Rapid immunochromatographic test is a kind of color reagent, which has colloid gold particles contained therein and has a layer of monoclonal antibody thereon, and which can show the result of an assay through presentation of colors according to immuno chromatographic principle. The antibody and antigen/protein of blood specimen to be assayed have specificity. Therefore, when blood specimen or serum specimen is dripped on the test, fluid in the specimen will move upwards along the test owing to capillarity, and the antigen/protein of the blood specimen to be assayed will be caught, and colors presented when the fluid reaches a test line of the test. Then, the specimen will continue to move, and colors are presented when it reaches a control line of the test; presentation of colors on the control line indicates that reaction of the specimen on the test has been completed while failure to present colors on both the test line and the control line means that the assay has failed.

However, the personnel have to make compare between shade of color, i.e. color intensity, of the test line and that of the control line to judge the result of the assay after colors have already been presented on the test; the concentration of the antigen/protein of the specimen is higher than that of the test line in case the test line has more intense shade of color than the control line, and the concentration of the antigen/protein of the specimen is lower than that of the test line in case the control line has a more intense shade of color than the test line. In other words, this assay only provides a semi-quantitative result, which is either “normal” (high concentration) or “abnormal” (low concentration) without exact figures being provided.

### SUMMARY OF THE INVENTION

It is a main object of the present invention to provide a method and apparatus for quantifying a rapid immunochromatographic test so that the results of a test with the rapid immunochromatographic test can be quantified, and exactly interpreted.

It is another main object of the present invention to provide a method and apparatus for quantifying various different rapid immunochromatographic tests so that the results of tests with the rapid immunochromatographic tests can be quantified, and exactly interpreted.

It is yet another main object of the present invention to provide a quantifying method and apparatus for rapid immunochromatographic tests, wherein image characteristics necessary for quantification can be updated.

The apparatus for quantifying a rapid immunochromatographic test is comprised of:
an image acquiring unit including ordinary image acquiring devices for acquiring a digital image of a rapid immunochromatographic test;
a characteristics acquiring unit for acquiring at least one characteristics of a digital image of a rapid immunochromatographic test, e.g. the test line, and the control line on the test, according to a series of digital image processing procedures;
a neural-network quantifying unit including plural trained plastic perception sub-networks, each of which corrects weights of the network by means of an algorithm of back propagation; the plastic perception sub-networks being combined to form a framework for quantifying the characteristics of the digital image;
a storage unit for storing plural parameters therein, which include plural characteristics related values, plural weights and plural critical values of the plastic perception sub-networks, and system related parameters; and
an output unit including a loudspeaker, LED, and an LCD for displaying results of the quantification.

Therefore, the apparatus can acquire main characteristics of a rapid immunochromatographic test through the optical image acquiring devices, and quantify the main characteristics through the neural-network quantifying unit, and display results of quantification on the output unit.

The method of the present invention includes the steps of:
(A) preparing a rapid immunochromatographic test to be quantified;
(B) positioning the test in an image acquiring unit, and acquiring a digital image of the test;
(C) carrying out initial judgment and differentiation on the digital image of the test;
(D) acquiring at least one main characteristics of the digital image through a characteristics acquiring unit;
(E) calculating and quantifying the main characteristics of the digital image through a neural-network quantifying unit; and
(F) sending results of the quantification to an output unit.

### BRIEF DESCRIPTION OF THE DRAWINGS

This invention will be better understood by referring to the accompanying drawings, wherein:

FIG. 1 is a block diagram of the quantification apparatus according to the present invention,

FIG. 2 is view of the framework of the plastic perception sub-networks according to the present invention,

FIG. 3 is a view of the back-propagation neural-network of the present invention,

FIG. 4 is a flow chart of the quantification method according to the present invention, and

FIG. 5 is a perspective view of the quantification apparatus according to the present invention.

### DETAILED DESCRIPTION OF THE PREFERRED EMBODIMENTS

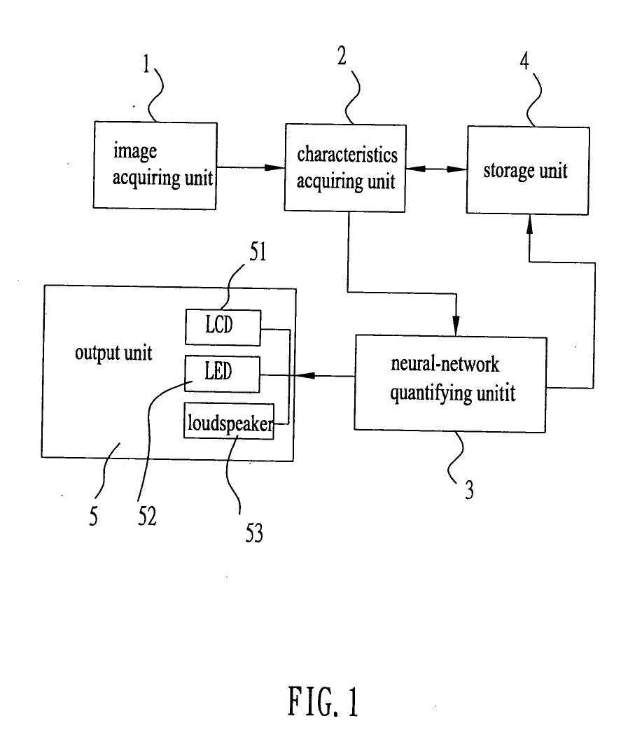

Referring to FIG. 1, a preferred embodiment of an apparatus for quantifying a rapid immunochromatographic test in the present invention includes an image acquiring unit 1, a characteristics acquiring unit 2, a neural-network quantifying unit 3, a storage unit 4, and an output unit 5.

The image acquiring unit 1 is provided for acquiring a digital image of a rapid immunochromatographic test to be quantified; the image acquiring unit 1 can be any ordinary optical image acquiring devices, wherein charge coupled devices (CCD)/complementary matal-oxide semiconductor (CMOS) image acquiring device is the best choice, and ordinary optical scanning devices, e.g. optical scanners, and automatic-document-feeding (ADF) high speed scanners, are the second best; a charge coupled devices (CCD)/complementary matal-oxide semiconductor (CMOS) image acquiring device acquires a digital image of a rapid immunochromatographic test much faster than ordinary optical scanning devices does therefore the time needed to acquire a digital image of a rapid immunochromatographic test is reduced in case a charge coupled devices (CCD)/complementary matal-oxide semiconductor (CMOS) image acquiring device is adopted.

The characteristics acquiring unit 2 is used for acquiring main characteristics of the digital image of a rapid immunochromatographic test according to a series of digital image processing procedures, which characteristics can be a test line, a control line etc.

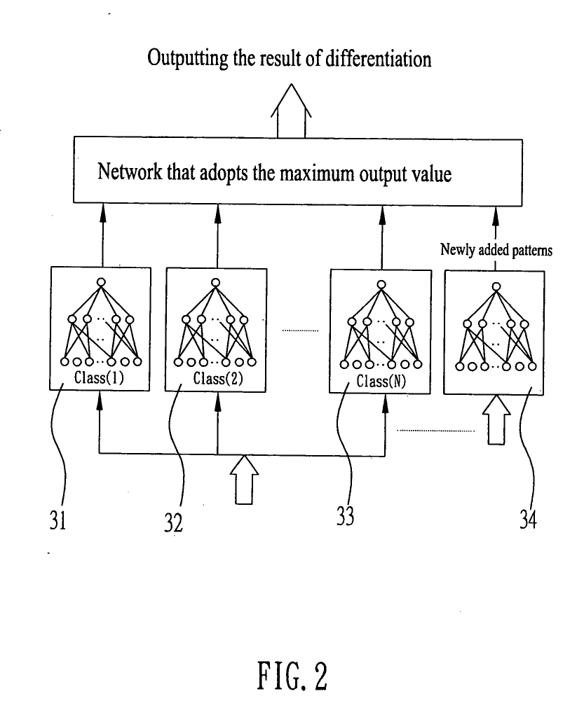

Plastic perception sub-networks 31, 32, and 33 are first built through plural weights and critical values in the neural-network quantifying unit 3. Then, the plastic perception sub-networks 31, 32, and 33 are trained, and combined to form a framework as shown in FIG. 2. The plastic perception sub-networks 31, 32, and 33 are comprised of many back propagation neural-networks, which include single hidden layer and single output node, and the numbers of plastic perception sub-networks are decided according to the numbers of the classifications. Each plastic perception sub-network 31, 32, 33 represents a classification. The plastic perception sub-networks 31, 32, and 33 are independent from each other, and can process separately in parallel. There are relatively small numbers of nodes in the hidden layers therefore each plastic perception sub-network 31, 32, 33 is allowed to rapidly converge, and an additional plastic perception sub-network 34, i.e. an additional classification, can be directly put in the framework without having to train the original sub-networks 31, 32, and 33 all over again, as shown in FIG. 2. Furthermore, plastic perception sub-networks 31, 32, and 33 are trained by means of algorithm of back propagation, and each is made to quantify the main characteristics of a rapid immunochromatographic test by means of algorithm of back propagation.

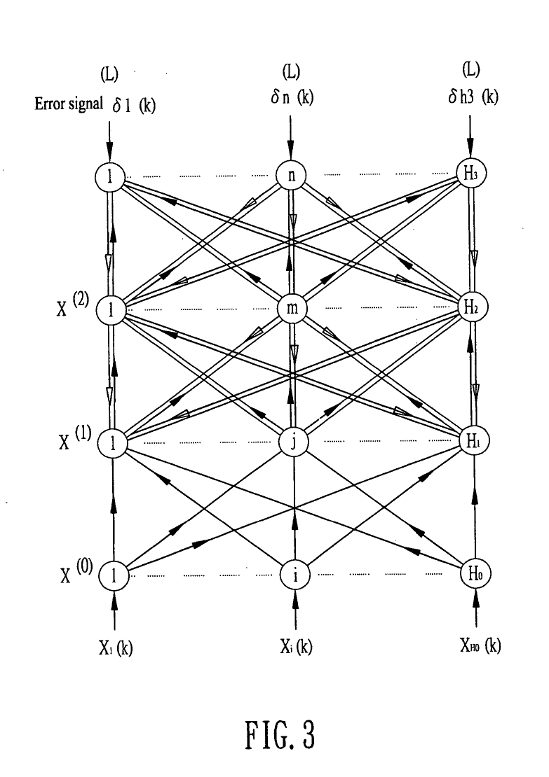

Referring to FIG. 3, the procedure for performing the algorithm of back propagation includes the following steps:
(1) initializing weights and critical values;
(2) inputting patterns and setting desired outputs;
(3) calculating actual outputs of networks;
(4) adjusting weights and critical values;
(5) returning to step 2 until all weights and all critical values are stable.

The storage unit 4 is a database, in which plural parameters are stored, including plural values related to characteristics, plural weights of sub-networks, critical values, and system related parameters. To quantify a rapid immunochromatographic test, characteristics of images are inputted in neural networks, which have been trained (with parameters set up therein), and the neural networks carry out calculations according to the parameters, i.e. the weights; the characteristics of images have to be quantified by respective neural networks, which have different parameters. In the present embodiment, the values related to characteristics are the criteria, according to which the plastic perception sub-networks 31, 32, and 33 perform quantification while the weights and the critical values are the criteria, according to which the neural-network quantifying unit 3 builds the algorithm of back propagation and the plastic perception framework of networks.

The output unit 5 is comprised of a liquid crystal display (LCD) 51, several light emitting diodes (LED) 52, and a loudspeaker 53. The loudspeaker 53 will make sound, which indicate completion of quantification, the LED 52 emit light or flash on and off, and results of quantification will be shown on the LCD 51 when the neural-network quantifying unit 3 sends the results to the output unit 5.

In addition, the characteristics acquiring unit 2 and the neural-network quantifying unit 3 process and calculate through electronic platforms such as microprocessors capable of carrying out high speed logical arithmetical operation, and digital signal processing (DSP) chip sets. And, the characteristics acquiring unit 2, the neural-network quantifying unit 3, and the storing unit 4 are integrated into a single integrated circuit platform.

Referring to FIGS. 1 to 4, the method for quantifying a rapid immunochromatographic test in the present invention includes the following steps:
(A) preparing a rapid immunochromatographic test to be quantified;
(B) positioning the test in an image acquiring unit 1, and acquiring a digital image of the test;
(C) carrying out initial differentiation on the digital image of the test;
(D) acquiring at least one main characteristics of the digital image through a characteristics acquiring unit 2;
(E) calculating and quantifying the main characteristics of the digital image, which is acquired in step (D), through a neural-network quantifying unit 3;
(F) sending the result of the quantification to an output unit 5.

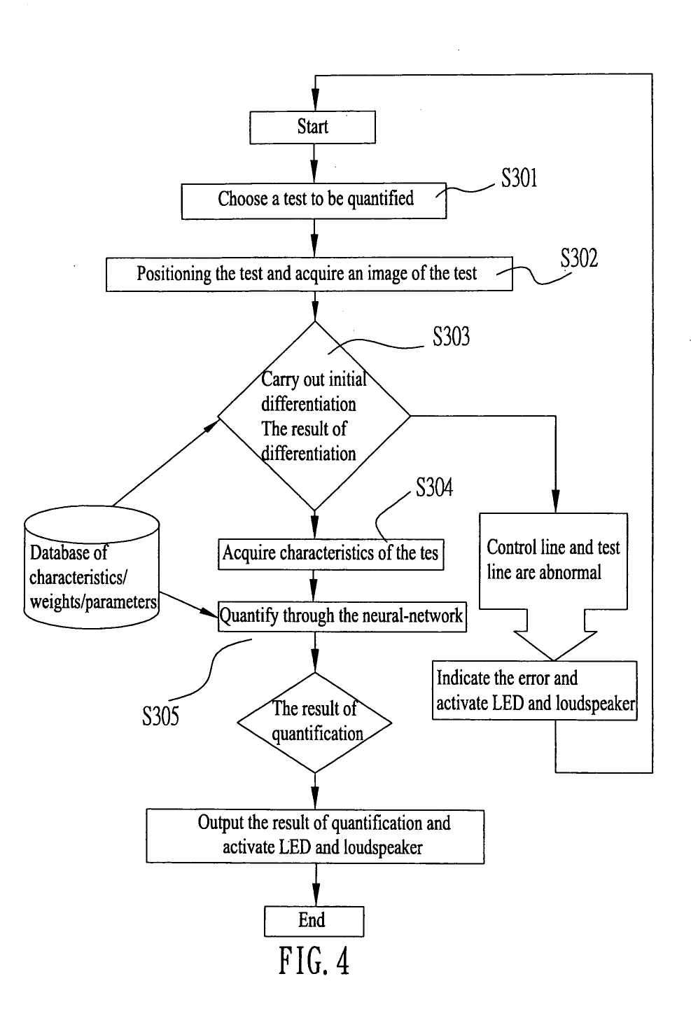

Therefore, as shown in FIG. 4, the procedure to quantify an Alpha-Fetalprotein immunochromatographic test according to the present method will include the following steps: [S301] choosing a rapid immunochromatographic test to be quantified, [S302] positioning the test in the image acquiring unit 1 as shown in FIG. 1, and acquiring a digital image of the test, [S303] carrying out initial analysis of the digital image so that initial judgment and differentiation on a test line and a control line of the test are made, in which initial judgment and differentiation a signal indicating “failure” will be provided in case only a test line or a control line of the test exists, and if both test line and control line exist, a signal indicating “normal” or one indicating “abnormal” will be provided according to the result of a comparison between the shades of the colors of the test line and the control line.

In case there is a signal indicating “abnormal”, the signal will be sent to the output unit 5 so that the loudspeaker 53 produces warning sound, the LED produce warning light, and an error message is displayed on the LCD 51.

The procedure to quantify an Alpha-Fetalprotein immunochromatographic test according to the present method further includes the steps of: [S304] acquiring main characteristics of the digital image of the test, e.g. a test line, and a control line, through the characteristics acquiring unit 2 no matter which one of the signals indicating “normal” and “abnormal” is provided, and [S305] sending the main characteristics of the digital image, which is acquired in step [S304], to the neural-network quantifying unit 3, and calculating and quantifying the main characteristics through the neural-network quantifying unit 3. Then, the result of the quantification is sent to the output unit 5 so that the loudspeaker 53 will make sound, which indicate completion of the quantification, the LED 52 emit light or flash on and off, and results of the quantification will be shown on the LCD 51.

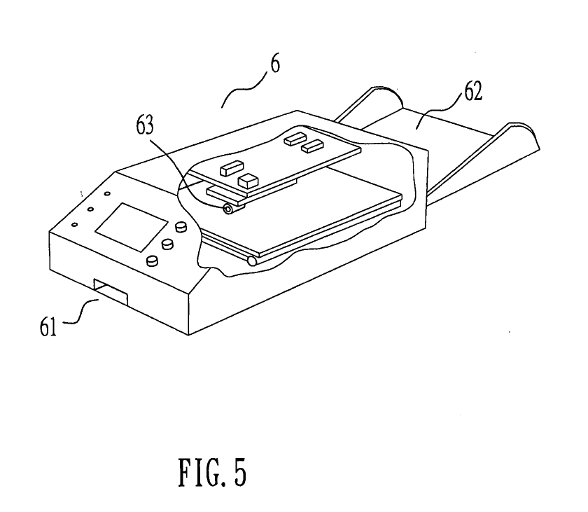

Referring to FIG. 5, a preferred embodiment of the apparatus for quantifying a rapid immunochromatographic test in the present invention has an entrance 61 for a test to be passed through, a charge coupled devices (CCD)/complementary matal-oxide semiconductor (CMOS) image acquiring device 63 for acquiring a digital image of a rapid immunochromatographic test, and an outlet 62 for a test to be passed through after quantification.

Of course, in order to use the present apparatus 6 to quantify different rapid immunochromatographic tests, e.g. Alpha-Fetalprotein immunochromatographic test, and PSA immunochromatographic test, one only has to first store trained external parameters in the storage unit 4 to adjust the original parameters of the storage unit 4, and train the plastic perception sub-networks 31, 32, and 33 of the neural-network quantifying unit 3. And, conventional algorithm of back propagation is used as the way to train plastic perception sub-networks.

From the above description, it can be understood that the apparatus of the present invention acquires a digital image of a rapid immunochromatographic test through a charge coupled devices (CCD)/complementary matal-oxide semiconductor (CMOS) image acquiring device 63, and acquires main characteristics of the digital image for the plastic perception sub-networks 31, 32, and 33 to carry out quantification of the main characteristics, which sub-networks 31, 32, and 33 have already been trained by means of the algorithm of back propagation, while the result of quantification is displayed on the LCD 51 of the output unit 5. Therefore, the personnel can easily judge a test with more precise data, and can update the data of the characteristics of images necessary for quantification by means of inputting retrained data of image characteristics in the storage unit 4 of the present quantifying apparatus 6. In other words, the present quantifying apparatus and method for immunochromatographic are convenient to use.

1. An apparatus for quantifying a rapid immunochromatographic test, comprising:
an image acquiring unit including optical image acquiring devices for acquiring a digital image of a rapid immunochromatographic test;
a characteristics acquiring unit for selectively acquiring at least one characteristics of a digital image of a rapid immunochromatographic test according to a series of digital image processing procedures;
a neural-network quantifying unit including a plurality of plastic perception sub-networks each used for quantifying main characteristics of a rapid immunochromatographic test according to an algorithm of back propagation;
a storage unit for storing a plurality of parameters therein, which include a plurality of characteristics related values, a plurality of weights and a plurality of critical values of the plastic perception sub-networks, and system related parameters; and
an output unit for displaying results of the quantification performed by the neural-network quantifying unit;
thereby capable of acquiring main characteristics of a rapid immunochromatographic test through the optical image acquiring devices, quantifying the main characteristics through the neural-network quantifying unit, and displaying results of quantification through the output unit.

2. The apparatus for quantifying a rapid immunochromatographic test as claimed in claim 1, wherein the main characteristics of a rapid immunochromatographic test include test line, and control line, which are quantifiable image characteristics of a rapid immunochromatographic test.

3. The apparatus for quantifying a rapid immunochromatographic test as claimed in claim 1, wherein the plastic perception sub-networks are built through a plurality of weights and critical values.

4. The apparatus for quantifying a rapid immunochromatographic test as claimed in claim 1, wherein the image acquiring unit is a charge coupled devices (CCD)/complementary matal-oxide semiconductor (CMOS) image acquiring device.

5. The apparatus for quantifying a rapid immunochromatographic test as claimed in claim 1, wherein the image acquiring unit is an optical scanning device.

6. The apparatus for quantifying a rapid immunochromatographic test as claimed in claim 1, wherein the characteristics acquiring unit processes and calculates through a microprocessor capable of carrying out high speed logical arithmetical operation.

7. The apparatus for quantifying a rapid immunochromatographic test as claimed in claim 1, wherein the characteristics acquiring unit processes and calculates through a digital signal processor.

8. The apparatus for quantifying a rapid immunochromatographic test as claimed in claim 1, wherein the neural-network quantifying unit processes and calculates through a microprocessor capable of carrying out high speed logical arithmetical operation.

9. The apparatus for quantifying a rapid immunochromatographic test as claimed in claim 1, wherein the neural-network quantifying unit processes and calculates through a digital signal processor.

10. The apparatus for quantifying a rapid immunochromatographic test as claimed in claim 1, wherein the output unit includes a liquid crystal display (LCD), a plurality of light emitting diodes (LED), and a loudspeaker.

11. The apparatus for quantifying a rapid immunochromatographic test as claimed in claim 1, wherein the characteristics acquiring unit, the neural-network quantifying unit, and the storing unit are integrated into a single integrated circuit platform.

12. A method for quantifying a rapid immunochromatographic test, comprising the steps of:
(A) preparing a rapid immunochromatographic test to be quantified;
(B) positioning the test in an image acquiring unit, and acquiring a digital image of the test;
(C) carrying out initial judgment and differentiation on the digital image of the test for finding out whether quantification of the test should proceed;
(D) acquiring at least one main characteristics of the digital image through a characteristics acquiring unit;
(E) calculating and quantifying the main characteristics of the digital image acquired in step (D) through a neural-network quantifying unit;
(F) sending results of the quantification to an output unit.

13. The method for quantifying a rapid immunochromatographic test as claimed in claim 12, wherein the image acquiring unit is a charge coupled devices (CCD)/complementary matal-oxide semiconductor (CMOS) image acquiring device.

14. The method for quantifying a rapid immunochromatographic test as claimed in claim 12, wherein the image acquiring unit is an optical scanning device.

15. The method for quantifying a rapid immunochromatographic test as claimed in claim 12, wherein in step (C), either one of “normal” condition and “abnormal” condition will be established according to a result of a comparison between shades of colors of a test line and a control line.

16. The method for quantifying a rapid immunochromatographic test as claimed in claim 12, wherein in step (D), the main characteristics include test line, and control line.

17. The method for quantifying a rapid immunochromatographic test as claimed in claim 12, wherein in step (D), a storage unit is used for storing a plurality of parameters therein, which include a plurality of characteristics related values, a plurality of weights and a plurality of critical values of the plastic perception sub-networks, and system related parameters.

18. The method for quantifying a rapid immunochromatographic test as claimed in claim 12, wherein the neural-network quantifying unit has a plastic perception sub-network built therein through a plurality of weights and critical values, and a plurality of characteristics related values are inputted into the plastic perception sub-network for the quantification step.

19. The method for quantifying a rapid immunochromatographic test as claimed in claim 12, wherein the output unit includes a liquid crystal display (LCD), a plurality of light emitting diodes (LED), and a loudspeaker.
